(19) United States
(12) Patent Application Publication
(10) Pub. No.: US 2008/0024477 A1
(43) Pub. Date: Jan. 31, 2008

(54) Plasma display device

(75) Inventors: Mikio Sasaki, Chuo-shi (JP); Shigeo Ide, Chuo-shi (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION

(21) Appl. No.: 11/878,276

(22) Filed: Jul. 23, 2007

(30) Foreign Application Priority Data
Jul. 26, 2006 (JP) 2006-203117

(51) Int. Cl. G06F 3/038

(52) U.S. Cl. 345/208

(57) ABSTRACT

A plasma display device which can provide stable discharging operations irrespective of variations in temperature. A load capacitor of a plasma display panel is charged or discharged via a switching element and a resistor element with one end to which a predetermined potential is supplied thereby creating a gradually varying waveform of a drive pulse, in which the switching element is controlled by an operational amplifier. That is, the operational amplifier controls the switching element based on a control voltage according to the difference between the potential at the other end of the resistor element and the potential of a gradually varying waveform generation signal for promoting the gradually varying waveform to be generated.

### BACKGROUND OF THE INVENTION

1. Technical Field

The present invention relates to a plasma display device which has capacitive light emitting elements disposed in a matrix.

2. Background Art

Nowadays, those plasma display devices which incorporate an AC type (Alternating Current discharge type) plasma display panel (hereinafter referred to as a PDP) are commercially available as a flat image display device. The PDP is configured such that a plurality of row electrodes intersect each of a plurality of column electrodes serving as address electrodes to define points of intersection. A discharge cell corresponding to a pixel is formed at each of the points of intersection.

The plasma display device drives such a PDP using a subfield method to display an image in gray scale levels corresponding to an input video signal. For example, when control is provided by the subfield method, one field display period is divided into a plurality of subfields, so that in each of the subfields, an initialization step, a pixel data write step, a sustain step, and an erase step are sequentially performed as follows. That is, in the initialization step, a simultaneous initialization discharge is established in all the discharge cells, thereby initializing the amount of wall charges to a predetermined amount in each of the discharge cells. In the pixel data write step, each discharge cell is selectively discharged based on an input video signal, thereby setting each discharge cell to either a light-on mode state in which a predetermined amount of wall charges remains unchanged or a light-off mode state in which the amount of wall charges is less than a predetermined amount. In the sustain step, only such discharge cells that are in the light-on mode are allowed to keep discharging continuously. In the erase step, an erase discharge is generated only in those discharge cells that are in the light-on mode, thereby causing the discharge cells to transition into the light-off mode.

The PDP includes drive circuits for generating drive pulses to create the aforementioned various types of discharges in each of the initialization step, the pixel data write step, the sustain step, and the erase step, and for applying the resulting pulses to the row and column electrodes (e.g., see FIG. 1 of Japanese Patent Kokai No. H11-133914 (Patent Document 1)). For example, the PDP includes an initialization pulse generation circuit S₂ for generating an initialization pulse as a drive pulse that is used to create an initialization discharge in the aforementioned initialization step. Also included is a sustain pulse generation circuit P for generating a sustain pulse serving as a drive pulse that is used to create a sustain discharge in the aforementioned sustain step.

Such an initialization pulse generation circuit S₂ includes a MOS (Metal Oxide Semiconductor) transistor Q with a predetermined voltage Vr applied to the drain terminal thereof, and a MOS transistor Q_{LS2} with the source terminal thereof connected to the ground and the drain terminal thereof connected to the source terminal of the MOS transistor Q. Furthermore, a capacitor C_{F2a} is interposed between the gate and the drain of the MOS transistor Q, with the gate terminal to which a drive voltage V_{IN} is supplied via a resistor R_{G2a} (a mirror integrating circuit). Here, when the MOS transistor Q is turned ON and the MOS transistor Q_{LS2} is turned OFF in response to the application of such a drive voltage V_{IN}, a current caused by the predetermined voltage Vr flows into an electrode of the PDP via the MOS transistor Q, creating an initialization pulse on the electrode of the PDP. Note that the current flowing through the resistor R_{G2a} also flows into the capacitor C_{F2a}. This causes a voltage V1 applied to the gate terminal of the MOS transistor Q in response to the application of the drive voltage V_{IN} to gradually increase, thereby causing the current flowing into the electrode of the PDP to also gradually increase. Accordingly, in the rising edge portion of the initialization pulse, the voltage increases at a gradual inclination. Here, the rising period t of the MOS transistor Q is expressed by

t=(C_{F2a}×Vr)/{(V_{IN}−V_{T})/R_{G2a}}

where V_{T} is the threshold voltage of the MOS transistor Q.

In this manner, the initialization pulse generation circuit S₂ shown in FIG. 1 of Patent Document 1 allows the MOS transistor Q to operate in an active region near its threshold voltage, thereby generating an initialization pulse that gradually changes in voltage in the rising edge portion.

However, in general, the threshold voltage of the MOS transistor varies significantly with temperatures, and thus changes in temperature will also cause variations in the current flowing through the MOS transistor itself. Accordingly, the inclination of voltage transition in the rising edge portion of the initialization pulse varies with temperatures, thus resulting in discharges being produced with instable timing.

### SUMMARY OF THE INVENTION

The present invention contemplates to solve aforementioned problems, and an object of the present invention is to provide a plasma display device which is capable of producing discharges with stability irrespective of variations in temperature.

A plasma display device according to a first aspect of the present invention includes a gradually varying waveform generation circuit for generating a drive pulse having a gradually varying waveform with a gradual voltage transition occurring in its rising or falling interval and for applying the resulting drive pulse to a display electrode of the plasma display panel. The gradually varying waveform generation circuit includes a resistor element with a predetermined potential applied to one end thereof; a switching element for connecting between the other end of the resistor element and the display electrode in response to a control voltage; and an operational amplifier for outputting, as the control voltage, a difference between the potential of a gradually varying waveform generation signal for promoting generation of the gradually varying waveform and the potential at the other end of the resistor element.

According to the aforementioned aspect of the present invention, the operational amplifier provides control to the switching element in order to generate a gradually varying waveform of the drive pulse by charging or discharging a load capacitor of the plasma display panel via the resistor element with a predetermined potential applied to one end thereof and the switching element. Here, the inverting input terminal of the operational amplifier is connected with the other end of the aforementioned resistor element and a gradually varying waveform generation signal for promoting generation of a gradually varying waveform is supplied to its non-inverting input terminal, with the output terminal of the operational amplifier connected to the control input terminal of the switching element. That is, the operational amplifier provides control to the aforementioned switching element according to the control voltage associated with the difference between the potential at the other end of the aforementioned resistor element and the potential of the gradually varying waveform generation signal. Such an arrangement allows a constant discharging current or charging current to flow through the aforementioned switching element and resistor element via a display electrode of the plasma display panel all the time without depending on the temperature characteristics of the threshold voltage of the switching element. Accordingly, even in the presence of a variation in temperature, the drive pulse can be maintained at a predetermined inclination of voltage transition in its rising or falling interval, thereby allowing discharges to be produced with stability.

### BRIEF DESCRIPTION OF THE DRAWINGS

FIG. 1 is a schematic view illustrating the configuration of a plasma display device;

FIG. 2 is a view illustrating a light-emission drive sequence according to a subfield method;

FIG. 3 is a view illustrating an example of various types of drive pulses to be applied to a PDP 10 in the plasma display device shown in FIG. 1;

FIG. 4 is a view illustrating an example of a gradually falling waveform generation circuit;

FIG. 5 is a view illustrating an example of a gradually rising waveform generation circuit;

FIG. 6 is a view illustrating the operation of the gradually falling waveform generation circuit shown in FIG. 4;

FIG. 7 is a view illustrating the operation of the gradually rising waveform generation circuit shown in FIG. 5;

FIG. 8 is a view illustrating a modified example of the gradually falling waveform generation circuit shown in FIG. 4;

FIG. 9 is a view illustrating a modified example of the gradually rising waveform generation circuit shown in FIG. 5;

FIG. 10 is a view illustrating the configuration of another gradually falling waveform generation circuit;

FIG. 11 is a view illustrating the configuration of another gradually rising waveform generation circuit;

FIG. 12 is a view illustrating the operation of the gradually falling waveform generation circuit shown in FIG. 10;

FIG. 13 is a view illustrating the operation of the gradually rising waveform generation circuit shown in FIG. 11;

FIG. 14 is a view illustrating a modified example of the gradually rising waveform generation circuit shown in FIG. 11;

FIG. 15 is a view illustrating a modified example of the gradually falling waveform generation circuit shown in FIG. 10; and

FIG. 16 is a view illustrating the operation of the gradually falling waveform generation circuit shown in FIG. 15.

### DETAILED DESCRIPTION OF THE INVENTION

Now, the present invention will be described below in more detail with reference to the accompanying drawings in accordance with the embodiments.

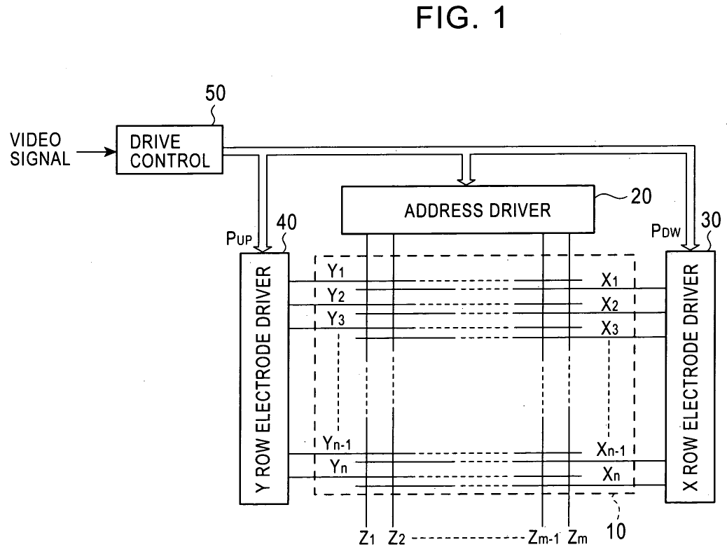

FIG. 1 is a schematic view illustrating the configuration of a plasma display device according to the present invention.

Referring to FIG. 1, a plasma display panel or a PDP 10 is provided with a front transparent substrate (not shown) serving as a display screen and a rear substrate (not shown) disposed in parallel spaced apart relation to the front transparent substrate. On the inner side of the front transparent substrate, there are disposed column electrodes (address electrodes) Z₁ to Zₘ each extending along the columns (vertically on the display screen). On the other hand, on the inner side of the rear substrate, row electrodes X₁ to Xn and row electrodes Y₁ to Yn are formed, with X and Y disposed alternately, each extending along the rows (horizontally on the display screen) as the display electrodes of the PDP 10. In this arrangement, each pair of row electrodes adjacent to each other, i.e., each of a row electrode pair (X₁, Y₁) to a row electrode pair (Xn, Yn) is associated with each of the 1st to nth display lines on the PDP 10. There is disposed a discharge gap between the front transparent substrate and the rear substrate to seal a discharge gas therein. In a region defined at a point of intersection between a row electrode pair (X, Y) and a column electrode Z, mentioned above, a discharge cell associated with each pixel is formed.

Based on an input video signal, a drive control circuit 50 generates a pixel data bit indicative of either the light-on mode or the light-off mode to which each of the discharge cells is to be set in each subfield (discussed later). Then, the resulting one display line worth of pixel data bits or m pixel data bits are supplied to an address driver 20 at a time.

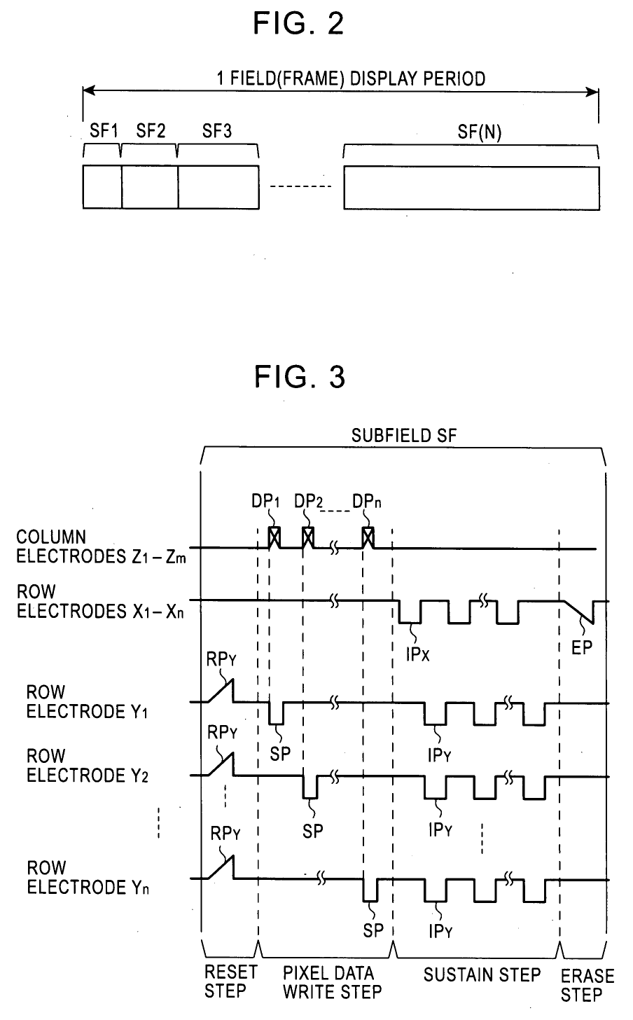

The drive control circuit 50 also supplies various types of drive control signals to an X row electrode driver 30 and a Y row electrode driver 40, thereby performing a pixel data write step and a sustain step in each subfield SF1 to SF(N), shown in FIG. 2, for each one frame (or one field) display period.

In the pixel data write step, the Y row electrode driver 40 generates a scan pulse SP of negative polarity, e.g., as shown in FIG. 3, and then sequentially applies it to each of the row electrodes Y₁, Y₂, Y₃, . . . , and Yn of the PDP 10. Meanwhile, the address driver 20 generates a pixel data pulse at a voltage corresponding to the aforementioned pixel data bit. For example, the address driver 20 generates pixel data pulses at a higher voltage when the pixel data bit indicates the light-on mode and at a lower voltage when it indicates the light-off mode. Then as shown in FIG. 3, at the timings synchronized with the scan pulse SP, a pixel data pulse train DP₁ of m pixel data pulses associated with the 1st display line, a pixel data pulse train DP₂ associated with the 2nd display line, . . . , and a pixel data pulse train DPn associated with the nth display line in that order are supplied to the column electrodes Z₁ to Zm of the PDP 10. In this process, a discharge is created only in a discharge cell to which the scan pulse SP and the pixel data pulse of the higher voltage have been applied at the same time, and this discharge cell is set to the light-on mode. On the other hand, no discharge is created in a discharge cell to which the scan pulse SP and the pixel data pulse of the lower voltage have been simultaneously applied, and thus this discharge cell is maintained at its immediately previous state (the light-on mode or the light-off mode).

Furthermore, in the sustain step, the X row electrode driver 30 generates a sustain pulse IP_{X} of positive polarity, as shown in FIG. 3, and then applies it to the row electrodes X₁ to Xn of the PDP 10 repeatedly as many times as corresponding to the weighted brightness of the subfield of interest. Meanwhile, with timing different from that of the aforementioned sustain pulse IP_{X}, the Y row electrode driver 40 generates a sustain pulse IP_{Y} of positive polarity, as shown in FIG. 3, and then applies it to the row electrodes Y₁ to Yn of the PDP 10 repeatedly as many times as corresponding to the weighted brightness of each subfield. As a result, in each of those discharge cells that are in the light-on mode, a sustain discharge is produced each time the aforementioned sustain pulse IP_{X} or IP_{Y} is applied thereto, and its light emitting state caused by the discharge is sustained.

Here, at least in the first subfield SF1 of the subfields SF1 to SF(N) shown in FIG. 2, a reset step is performed, prior to the aforementioned pixel data write step, in order to initialize the states of all the discharge cells (the firing or non-firing mode states). In such a reset step, the Y row electrode driver 40 generates a reset pulse RP_{Y} in a waveform, which gradually increases in potential with time leading to a peak potential of positive polarity as shown in FIG. 3, and then applies it to all the row electrodes Y₁ to Yn at the same time. In response to the application of the reset pulse RP_{Y}, a reset discharge is produced in all the discharge cells, thereby causing all the discharge cells to be initialized to either the light-on mode state or the light-off mode state.

On the other hand, in the last subfield (N), an erase step is performed to transition a discharge cell in the light-on mode state into the light-off mode after the aforementioned sustain step has been performed. In such an erase step, the X row electrode driver 30 generates an erase pulse EP in a waveform which gradually decreases in potential with time leading to a peak potential of negative polarity as shown in FIG. 3, and then applies it to all the row electrodes X₁ to Xn at the same time. In response to the application of the erase pulse EP, an erase discharge is produced only in each of those discharge cells that are in the light-on mode state. This erase discharge causes a discharge cell in the light-on mode state to transition to the light-off mode state.

Here, the X row electrode driver 30 includes a gradually falling waveform generation circuit for generating a waveform in the falling interval of the aforementioned erase pulse EP of negative polarity, i.e., a waveform which gradually decreases in potential with time leading to a peak potential. On the other hand, the Y row electrode driver 40 includes a gradually rising waveform generation circuit for generating a waveform in the rising interval of the aforementioned reset pulse RP_{Y} of positive polarity, i.e., a waveform which gradually increases in potential with time leading to a peak potential.

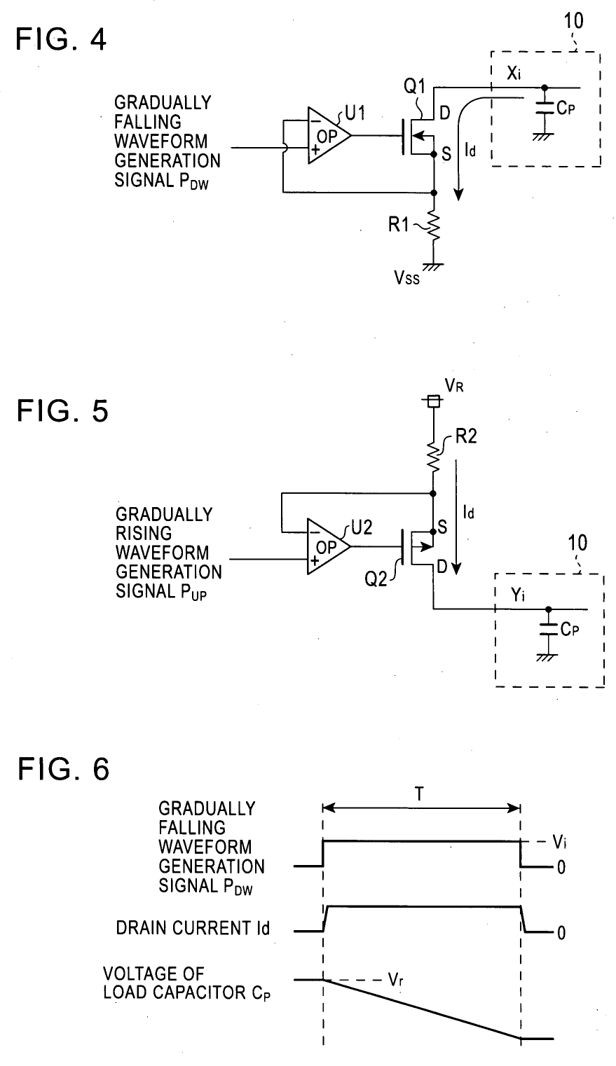

FIGS. 4 and 5 illustrate the internal configurations of the gradually falling waveform generation circuit and the gradually rising waveform generation circuit, described above, respectively.

As shown in FIG. 4, the gradually falling waveform generation circuit includes an operational amplifier U1, a transistor Q1 or a MOSFET (Metal Oxide Semiconductor Field Effect Transistor), and a resistor R1 with a predetermined reference potential Vss (e.g., 0 volt) applied to one end thereof.

The non-inverting input terminal of the operational amplifier U1 is supplied with a gradually falling waveform generation signal P_{DW} delivered from the drive control circuit 50. The output terminal of the operational amplifier U1 is connected to the gate terminal of the transistor Q1, which serves as a control input terminal. The source terminal of the transistor Q1 is connected with the other end of the resistor R1 and the inverting input terminal of the operational amplifier U1. The drain terminal of the transistor Q1 is connected to a row electrode X of the PDP 10.

On the other hand, as shown in FIG. 5, the gradually rising waveform generation circuit includes an operational amplifier U2, a MOSFET transistor Q2, and a resistor R2 with one end to which a power supply potential V_{R} serving as a charge source in creating a gradually rising waveform is applied.

To the non-inverting input terminal of the operational amplifier U2, a gradually rising waveform generation signal P_{UP} delivered from the drive control circuit 50 is supplied. The output terminal of the operational amplifier U2 is connected to the gate terminal of the transistor Q2, which serves as a control input terminal. The source terminal of the transistor Q2 is connected with the other end of the resistor R2 and the inverting input terminal of the operational amplifier U2. The drain terminal of the transistor Q2 is connected to a row electrode Y of the PDP 10.

Now, a description will be made to the operations of each of the gradually falling waveform generation circuit and the gradually rising waveform generation circuit shown in FIGS. 4 and 5, respectively.

For example, the erase pulse EP is created in the erase step as shown in FIG. 3. To this end, the drive control circuit 50 supplies the gradually falling waveform generation signal P_{DW} for maintaining a potential Vi over a predetermined period T as shown in FIG. 6 to the gradually falling waveform generation circuit of the X row electrode driver 30. Note that immediately before the aforementioned erase step, the load capacitor C_{P} of the PDP 10 has been charged through a sustain discharge in the sustain step. Accordingly, the potential Vr of the load capacitor C_{P} which has been charged as such is applied to the drain terminal of the transistor Q1 via a row electrode X.

Here, suppose that the potential Vi according to the gradually falling waveform generation signal P_{DW} is supplied to the non-inverting input terminal of the operational amplifier U1. In this case, the operational amplifier U1 supplies a gate voltage (control voltage) to the gate terminal of the transistor Q1 so that the potential on its inverting input terminal, i.e., the potential on the source terminal of the transistor Q1 agrees with the aforementioned potential Vi. This causes a drain current Id to flow between the drain and the source of the transistor Q1 and through the resistor R1 according to the charges accumulated in the load capacitor C_{P}. At this time, since the potential on the source terminal of the transistor Q1 becomes equal to the potential Vi according to the aforementioned gradually falling waveform generation signal P_{DW}, the drain current Id expressed by the following equation flows over the predetermined period T:

Id=Vi/R1.

Accordingly, the charges accumulated by the drain current Id in the load capacitor C_{P} of the PDP 10 are discharged, thereby causing the potential of the load capacitor C_{P}, i.e., the potential on the row electrode X to gradually decrease with time as shown in FIG. 6.

At this time, the potential V_{P} of the load capacitor C_{P} is expressed by the following equation:

$$\begin{matrix}{V}_{P} = Vr - ( Id \cdot t / {C}_{P} ) \\ = Vr - ( Vi \cdot t / {C}_{P} \cdot R 1 )\end{matrix}$$

where t is the elapsed time from the application of the potential Vi.

That is, as shown in FIG. 6, the potential of load capacitor C_{P} gradually decreases from the state of the aforementioned potential Vr with time from the time at which the gradually falling waveform generation signal P_{DW} started to cause the application of the potential Vi. The waveform during this potential decreasing interval is a gradually varying waveform in the falling interval of the erase pulse EP shown in FIG. 3.

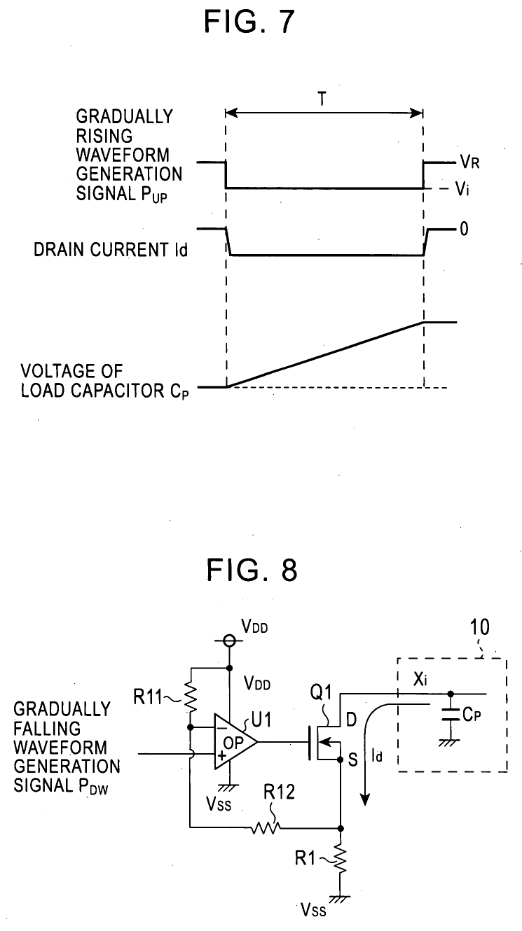

Furthermore, the reset pulse RP_{Y} is created in the reset step as shown in FIG. 3. To this end, the drive control circuit 50 supplies the gradually rising waveform generation signal P_{UP} to the gradually rising waveform generation circuit of the Y row electrode driver 40 to maintain the potential Vi (V_{R}>Vi) over a predetermined period T as shown in FIG. 7. Note that immediately before the reset step, the load capacitor C_{P} of the PDP 10 is in the discharged state and thus has a potential of 0 volt. Accordingly, during this time, the drain terminal of the transistor Q2 has 0 volt applied thereto via the row electrode Y.

Here, suppose that the potential Vi according to the gradually rising waveform generation signal P_{UP} is supplied to the non-inverting input terminal of the operational amplifier U2. In this case, the operational amplifier U2 supplies a gate voltage (control voltage) to the gate terminal of the transistor Q2 so that the potential on its inverting input terminal, i.e., the potential on the source terminal of the transistor Q2 agrees with the aforementioned potential Vi. This causes a drain current Id to flow between the drain and the source of the transistor Q2 and through the resistor R2 according to the power supply potential V_{R}. At this time, since the potential on the source terminal of the transistor Q2 becomes equal to the potential Vi according to the aforementioned gradually rising waveform generation signal P_{UP}, the drain current Id expressed by the following equation flows over the predetermined period T:

Id=−Vi/R2.

Accordingly, the drain current Id charges the load capacitor C_{P} of the PDP 10, thereby causing the potential of the load capacitor C_{P}, i.e., the potential on the row electrode Y to gradually increase with time as shown in FIG. 7.

At this time, the potential V_{P} of the load capacitor C_{P} is expressed by the following equation:

$$\begin{matrix}{V}_{P} = Id \cdot t / {C}_{P} \\ = Vi \cdot t / {C}_{P} \cdot R 2\end{matrix}$$

where t is the elapsed time from the application of the potential Vi.

That is, as shown in FIG. 7, the potential of the load capacitor C_{P} increases gradually from the 0 volt state with time from the time at which the gradually rising waveform generation signal P_{UP} started to cause the application of the potential Vi. The waveform during this potential increasing interval is a gradually varying waveform in the rising interval of the reset pulse RP_{Y} shown in FIG. 3.

As described above, the gradually varying waveform is generated by charging or discharging the load capacitor of the PDP via the transistor (Q1 or Q2) and the resistor element (R1 or R2) with the predetermined potential (V_{SS} or V_{R}) applied to its one end. To this end, the gradually varying waveform generation circuit shown in FIG. 4 or 5 allows the operational amplifier (U1 or U2) to provide control. That is, the operational amplifier (U1 or U2) generates a control voltage (gate voltage) corresponding to the difference between the potential on the other end of the aforementioned resistor element (R1 or R2) and the potential of the gradually varying waveform generation signal (P_{DW} or P_{UP}) and controls the transistor (Q1 or Q2) based on the control voltage. According to such an arrangement, the potential on the drain terminal or the source terminal of the transistor (Q1 or Q2) is equal to the potential (Vi) of the gradually varying waveform generation signal (P_{DW} or P_{UP}) supplied to the aforementioned operational amplifier (U1 or U2). That is, the operational amplifier (U1 or U2) controls the transistor (Q1 or Q2) so that a constant drain current (Id) flows therethrough corresponding to the potential (Vi) of the gradually varying waveform generation signal (P_{DW} or P_{UP}). At this time, to discharge the load capacitor (C_{P}) of the PDP (as in the arrangement shown in FIG. 4), such control serves to generate a gradually falling waveform which causes its potential to gradually decrease with time. On the other hand, to charge the load capacitor (C_{P}) of the PDP (as in the arrangement shown in FIG. 5), such control serves to generate a gradually rising waveform which increases gradually in its potential with time.

At this time, the arrangement as shown in FIG. 4 or 5 allows a constant drain current (Id) to flow as a discharging current or a charging current without depending on the temperature characteristics of the threshold voltage of the transistor. Accordingly, even in the presence of a variation in temperature, no variation in the inclination of potential transition would occur in the rising or falling interval of each of the various drive pulses. It is thus possible to provide stable discharging operations irrespective of variations in temperature.

Note that in the arrangement as shown in FIG. 4 or 5, a higher offset voltage of the operational amplifier U1 (or U2) would not allow the voltage across the resistor R1 (or R2) to be 0 volt even when the gradually falling waveform generation signal P_{DW} (or P_{UP}) is indicative of 0 volt. At this time, even while a gradually varying waveform is not being created, the drain current Id flows through the transistor Q1 (or Q2), thereby causing power to be wasted.

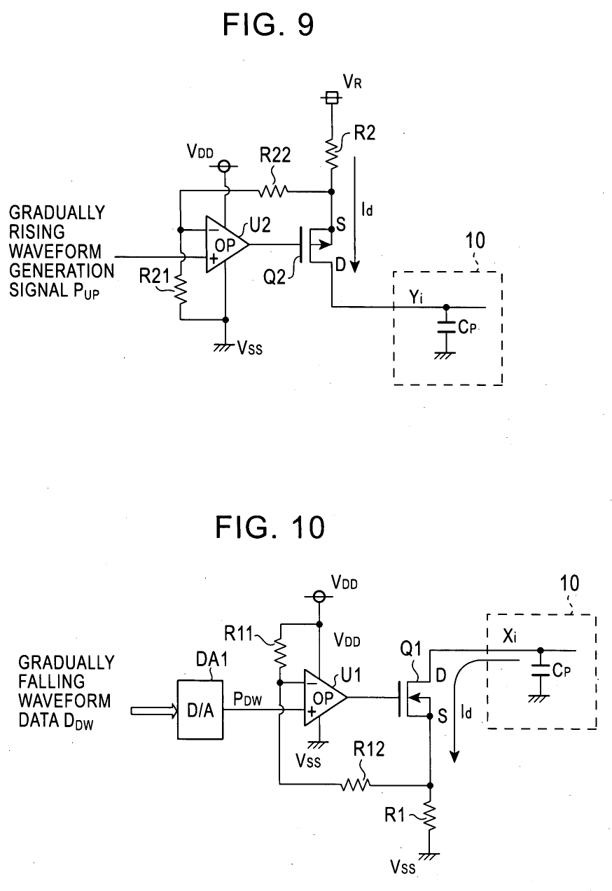

In this regard, to overcome such a problem, it is also acceptable to employ a gradually falling waveform generation circuit shown in FIG. 8 instead of the one of FIG. 4, and a gradually rising waveform generation circuit as shown in FIG. 9 instead of the arrangement shown in FIG. 5.

Note that the arrangement of FIG. 8 is the same as the one shown in FIG. 4 except that a power supply voltage V_{DD} (not shown in FIG. 4) supplied to the operational amplifier U1 is applied to the inverting input terminal of the operational amplifier U1 via a resistor R11, and the inverting input terminal is connected to the source terminal of the transistor Q1 via a resistor R12. That is, in the arrangement as shown in FIG. 8, the power supply voltage V_{DD} to be supplied to operate the operational amplifier U1 is arranged by the voltage divider consisting of the resistor R11, the resistor R12, and the resistor R1 to obtain a potential. This potential is in turn applied as an offset voltage to the inverting input terminal of the operational amplifier U1.

On the other hand, the arrangement of FIG. 9 is the same as the one shown in FIG. 5 except that the reference potential Vss (not shown in FIG. 5) to be applied to the operational amplifier U2 is applied to the inverting input terminal of the operational amplifier U1 via a resistor R21, and the inverting input terminal is connected to the source terminal of the transistor Q2 via a resistor R22.

As such, in the arrangements shown in FIGS. 8 and 9, the application of the offset voltage to the inverting input terminal of the operational amplifier (U1 or U2) ensures that the transistor (Q1 or Q2) is set to the OFF state in response to the gradually varying waveform generation signal (P_{DW} or P_{UP}) of 0 volt even in the presence of an offset in the operational amplifier.

Furthermore, in the aforementioned embodiment, the application of 0 volt or the potential Vi to the non-inverting input terminal of the operational amplifier (U1 or U2) allows a gradually varying waveform having a predetermined inclination. The potential to be applied to the non-inverting input terminal is allowed to vary with time, thereby making it possible to create various types of gradually varying waveforms.

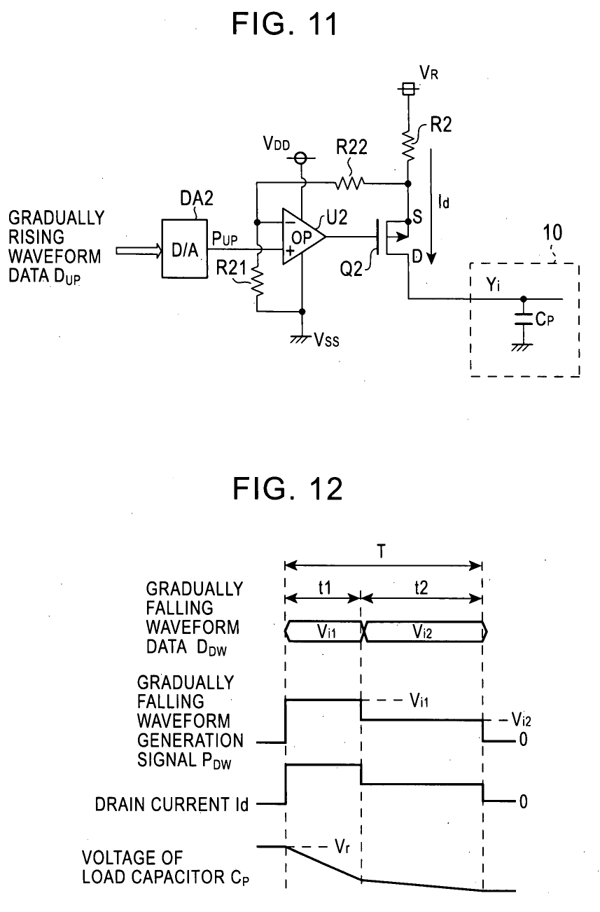

FIGS. 10 and 11 are views illustrating the configurations of other gradually varying waveform generation circuits developed in view of these points.

The gradually falling waveform generation circuit shown in FIG. 10 is the same as the one shown in FIG. 8 except that a D/A converter DA1 is disposed at the preceding stage of the operational amplifier U1. The D/A converter DA1 converts gradually falling waveform data D_{DW} supplied from the drive control circuit 50 into the gradually falling waveform generation signal P_{DW} having an analog signal level for delivery to the non-inverting input terminal of the operational amplifier U1. For example, as shown in FIG. 12, suppose that the gradually falling waveform data D_{DW} supplied is representative of a potential Vᵢ₁ over a former period t1 and a potential Vᵢ₂ over the latter period t2 within a predetermined period T. In this case, the D/A converter DA1 generates the gradually falling waveform generation signal P_{DW} which has the potential Vᵢ₁ during the former period t1 and the potential Vᵢ₂ during the latter period t2. At this time, the source terminal of the transistor Q1 has the potential Vᵢ₁ during the former period t1 and the potential Vᵢ₂ during the latter period t2. Accordingly, a drain current Id flows through the transistor Q1 according to the potential Vᵢ₁ during the former period t1 within the predetermined period T, while a drain current Id flows therethrough according to the potential Vᵢ₂ during the latter period t2. Thus, as shown in FIG. 12, the potential of the load capacitor C_{P} of the PDP 10 gradually decreases at inclinations different from each other during the former period t1 and the latter period t2, so that the waveform in the potential decreasing interval is the gradually varying waveform in the falling interval of the drive pulse.

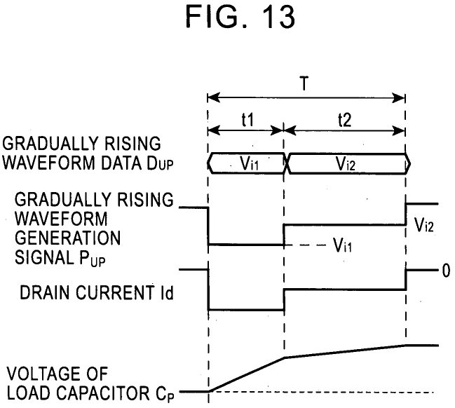

On the other hand, the gradually rising waveform generation circuit shown in FIG. 11 is the same as the one shown in FIG. 9 except that a D/A converter DA2 is disposed at the preceding stage of the operational amplifier U2. The D/A converter DA2 converts gradually rising waveform data D_{UP} supplied from the drive control circuit 50 into the gradually rising waveform generation signal P_{UP} having an analog signal level for delivery to the non-inverting input terminal of the operational amplifier U2. For example, as shown in FIG. 13, suppose that the gradually rising waveform data D_{UP} supplied is representative of a potential Vᵢ₁ over a former period t1 and a potential Vᵢ₂ over the latter period t2 within a predetermined period T. In this case, the D/A converter DA2 generates the gradually rising waveform generation signal P_{UP} which has the potential Vᵢ₁ during the former period t1 and the potential Vᵢ₂ during the latter period t2. At this time, the source terminal of the transistor Q2 has the potential Vᵢ₁ during the former period t1 and the potential Vᵢ₂ during the latter period t2. Accordingly, a drain current Id flows through the transistor Q2 according to the potential Vᵢ₁ during the former period t1 within the predetermined period T, while a drain current Id flows therethrough according to the potential Vᵢ₂ during the latter period t2. Thus, as shown in FIG. 13, the potential of the load capacitor C_{P} of the PDP 10 increases gradually at inclinations different from each other during the former period t1 and the latter period t2, so that the waveform in the potential increasing interval is the gradually varying waveform in the rising interval of the drive pulse.

In this manner, the gradually varying waveform generation circuits shown in FIGS. 10 and 11 can create gradually varying waveforms which have any inclination suitable for the discharge characteristics of the PDP 10.

Here, in the arrangement shown in FIG. 11, it is ensured that the operational amplifier U2 drives the transistor Q2 which produces the drain current Id by supplying the power supply potential V_{R} thereto. To this end, for example, a photocoupler or the like has to be included to convert the output voltage from the operational amplifier U2 into a voltage that enables the transistor Q2 to operate. However, a photocoupler interposed between the output terminal of the operational amplifier U2 and the transistor Q2 would ensure a fast response speed with difficulty when a PWM (Pulse Width Modulation) type converter is used as the D/A converter DA2.

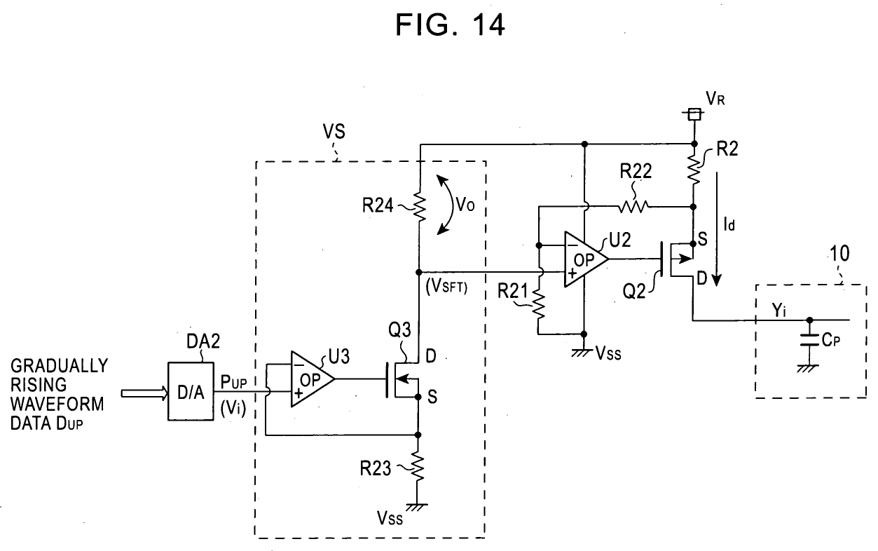

FIG. 14 is a view illustrating an exemplary improvement which was made to the gradually rising waveform generation circuit (shown in FIG. 11) to overcome such a problem.

Note that the arrangement shown in FIG. 14 is the same as the one shown in FIG. 11 except that a voltage shift circuit VS is added to the arrangement shown in FIG. 11 and the operational amplifier U2 is operated with a power supply potential V_{R} serving as a charge supply source for generating a gradually rising waveform.

As shown in FIG. 14, the voltage shift circuit VS includes an operational amplifier U3, a MOSFET transistor Q3, a resistor R23, and a resistor R24. To the non-inverting input terminal of the operational amplifier U3, a gradually rising waveform generation signal P_{UP} delivered from the D/A converter DA2 is supplied. The output terminal of the operational amplifier U3 is connected to the gate terminal of the transistor Q3. The source terminal of the transistor Q3 is connected with one end of the resistor R23 and the inverting input terminal of the operational amplifier U3. Note that the other end of the resistor R23 is grounded to the reference potential Vss (e.g., 0 volt). The drain terminal of the transistor Q3 is connected to the non-inverting input terminal of the operational amplifier U2 and one end of the resistor R24. To the other end of the resistor R24 the power supply potential V_{R} serving as a charge supply source when creating a gradually rising waveform is supplied. The operational amplifier U2 operates with the power supply potential V_{R}.

This arrangement allows the voltage shift circuit VS to generate a current corresponding to the signal level (voltage Vi) of the gradually rising waveform generation signal P_{UP} delivered from the D/A converter DA2 and then allows the resulting current to flow through the resistor R24, thereby producing a voltage V₀, as expressed by the following equation, across the resistor R24:

V₀=Vi·(R24/R23)

That is, at this time, to the non-inverting input terminal of the operational amplifier U2, supplied is a gradually rising waveform generation signal, i.e., the gradually rising waveform generation signal P_{UP} whose potential Vi has been shifted to a voltage V_{SFT} expressed by the following equation:

$$\begin{matrix}{V}_{SFT} = {V}_{R} - {V}_{0} \\ = {V}_{R} - Vi \cdot ( R 24 / R 23 )\end{matrix}$$

In this manner, the gradually rising waveform generation circuit shown in FIG. 14 is adapted such that the operational amplifier U2 is operated with the power supply potential V_{R}, and the potential Vi of the gradually rising waveform generation signal P_{UP} is shifted to the voltage V_{SFT} by the voltage shift circuit VS for delivery to the operational amplifier U2. Such an arrangement can ensure that the transistor Q2 is driven without providing a voltage conversion element such as a photocoupler between the output terminal of the operational amplifier U2 and the gate terminal of the transistor Q2.

In the embodiments as shown in FIGS. 10 and 11, the D/A converter (DA1 or DA2) generates a gradually varying waveform generation signal (P_{UP} or P_{DW}) in order to generate a gradually varying waveform having an arbitrary inclination. However, in place of the D/A converter, it is also possible to employ a differentiating circuit or an integrating circuit.

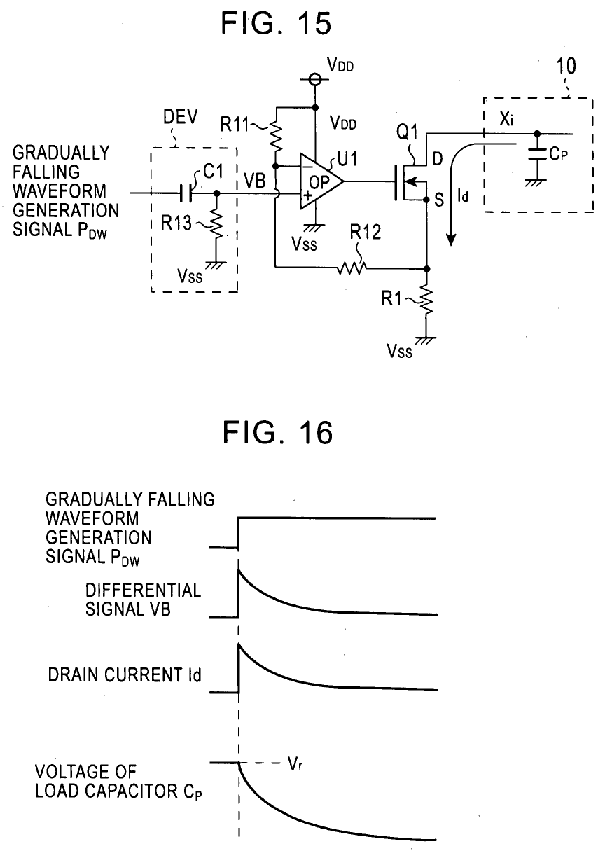

FIG. 15 is a view illustrating a modified example of the gradually falling waveform generation circuit shown in FIG. 10, in which a differentiating circuit DEV including a capacitor C1 and a resistor R13 is employed instead of the D/A converter DA1.

FIG. 16 is a view illustrating by way of example a differential signal VB delivered by the differentiating circuit DEV in response to the gradually falling waveform generation signal P_{DW} supplied from the drive control circuit 50. FIG. 16 also shows a drain current Id flowing through the transistor Q1 in response to the differential signal VB, and a gradually falling waveform (the potential of the load capacitor C_{P}) produced by the drain current Id.

Furthermore, in the aforementioned embodiments, a MOSFET or a so-called field effect transistor is employed as the transistors Q1 to Q3 serving as a switching element; however, a bipolar transistor may also be employed. For example, suppose that the transistor Q1 shown in FIG. 4 is a bipolar transistor. In this case, the base terminal serving as the control input terminal is connected to the output terminal of the operational amplifier U1, the collector terminal is connected to the row electrode X of the PDP 10, and the emitter terminal is connected to the inverting input terminal of the operational amplifier and the resistor R1.

Furthermore, as the transistors Q1 to Q3, an insulated gate bipolar transistor may also be employed which has a MOSFET structure only for the gate region. For example, suppose that the transistor Q1 shown in FIG. 4 is an insulated gate bipolar transistor. In this case, the gate terminal is connected to the output terminal of the operational amplifier U1, the collector terminal is connected to the row electrode X of the PDP 10, and the emitter terminal is connected to the resistor R1 and the inverting input terminal of the operational amplifier.

What is claimed is:

1. A plasma display device comprising a gradually varying waveform generation circuit for generating a drive pulse having a gradually varying waveform with a gradual voltage transition occurring in a rising or falling interval and for applying the resulting drive pulse to a display electrode of the plasma display panel, wherein
the gradually varying waveform generation circuit includes:
a resistor element with a predetermined potential applied to one end thereof;
a switching element for connecting between the other end of the resistor element and the display electrode in response to a control voltage; and
an operational amplifier for outputting, as the control voltage, a difference between a potential of a gradually varying waveform generation signal for promoting generation of the gradually varying waveform and a potential at the other end of the resistor element.

2. The plasma display device according to claim 1, wherein
the drive pulse is a reset pulse to be applied to initialize a state of wall charges in each pixel cell of the plasma display panel.

3. The plasma display device according to claim 1, wherein
the drive pulse is an erase pulse to be applied to erase wall charges in each pixel cell of the plasma display panel.

4. The plasma display device according to claim 1, wherein
the switching element is a MOS field effect transistor, a drain terminal of the field effect transistor is connected to the display electrode, a source terminal of the field effect transistor is connected to the other end of the resistor element, and a gate terminal of the field effect transistor is connected with the output terminal of the operational amplifier.

5. The plasma display device according to claim 1, wherein
the switching element is an insulated gate bipolar transistor, a collector terminal of the insulated gate bipolar transistor is connected to the display electrode, an emitter terminal of the insulated gate bipolar transistor is connected to the other end of the resistor element, and a gate terminal of the insulated gate bipolar transistor is connected with an output terminal of the operational amplifier.

6. The plasma display device according to claim 1, wherein
the switching element is a bipolar transistor, a collector terminal of the bipolar transistor is connected to the display electrode, an emitter terminal of the bipolar transistor is connected to the other end of the resistor element, and a base terminal of the bipolar transistor is connected with an output terminal of the operational amplifier.

7. The plasma display device according to claim 1, wherein
an inverting input terminal of the operational amplifier is connected with the other end of the resistor element, said gradually varying waveform generation signal is supplied to a non-inverting input terminal of the operational amplifier, and an output terminal of the operational amplifier is connected to a control input terminal of the switching element.

8. The plasma display device according to claim 7, wherein
a predetermined offset voltage is applied to the inverting input terminal of the operational amplifier.
